(19) United States
(12) Patent Application Publication
(10) Pub. No.: US 2012/0296692 A1
(43) Pub. Date: Nov. 22, 2012

(54) SYSTEM AND METHOD FOR MANAGING A FRAUD EXCHANGE

(76) Inventors: John Edward O'Malley, Winter Park, FL (US); Maria Margaret Loughlin, Bedford, MA (US); Yakov I. Sverdlov, Newton, MA (US); Mark Jeffrey Waks, Burlington, MA (US)

(21) Appl. No.: 13/111,804

(22) Filed: May 19, 2011

(51) Int. Cl. G06Q 10/00

(52) U.S. Cl. 705/7.28

(57) ABSTRACT

Systems and methods for presenting fraud detection information are presented. In one example, a computer system for managing and enabling communication of information potentially pertinent to identifying fraudulent activity receives requests via a producer interface, to store a plurality of data points potentially pertinent to identifying fraudulent activity from a plurality of source systems. A fraud exchange engine performs an analysis of the data points to produce a relational data point. And a consumer interface receives, from at least one target system, a request to retrieve at least one of a set of the plurality of data points and the at least one relational data point.

### BACKGROUND

1. Technical Field

Aspects of examples disclosed herein relate to systems and methods for managing risk by detecting fraudulent activity and more particularly to apparatus and processes for integrating, analyzing and publishing information potentially indicative of fraudulent activity that is received from a plurality of source systems.

2. Discussion of Related Art

Fraudulent activities belonging to various categories are a significant issue for a wide variety of business concerns. For instance, within the U.S. retail industry, employee theft totals close to $16 billion annually. While in the U.S. healthcare industry, waste and abuse amounts to between $125 and $175 billion annually. Similarly, the U.S. financial sector is plagued with frauds including check fraud, ATM fraud, debit fraud and credit fraud. For example, check fraud, which is a perennial problem in the financial sector, amounts to approximately $1 billion in losses annually.

Fraudulent activity may be tracked using a variety of fraud detection systems. Some of these systems may include business intelligence systems, public data aggregation systems, IT security systems, and financial transaction processors. Some of these systems analyze data representative of human conduct and assess the likelihood that the activity was conducted for a genuine or a fraudulent purpose.

### SUMMARY OF INVENTION

Typical software packages designed to aid in the detection of fraudulent activities offer rudimentary user interfaces that display unadorned transactional information. Users of these software packages are often forced to review large amounts of this transactional information in search of fraudulent activity. Other enterprise fraud management systems may perform some analyses of transaction information, but are usually unable to share this information with other systems. Because these fraud management systems are highly fragmented, they do not detect fraud across different information source systems and information consumer systems. For example, within the financial sector, fraudulent detection systems from various vendors operate as discrete entities within each financial institution without sharing related activity with other financial institutions. Any communication between such systems occurs only through custom and vendor-specific interfaces. Such limited communication restricts the sphere of distribution of related information, which is often crucial to the detection of fraudulent activity.

Accordingly, there is a need for systems and methods of managing and enabling communication of information related to potential fraudulent activity that are vendor and system agnostic. Such systems and methods streamline communications between producers and consumers of potentially fraudulent information and identify potentially fraudulent activity across different users, accounts, channels, products and institutions.

Aspects and examples disclosed herein are directed to a fraud exchange system that includes a producer and a consumer interface. The producer interface, in some examples, is configured to receive information from a number of diverse sources of information. For example, information or data received from these sources may include but is not limited to information indicative of fraudulent behavior, information indicative of authentic or genuine behavior, reference or background information, or transactional information. According to various examples, the consumer interface handles requests for information from a diverse number of business systems. The consumer and producer interfaces described herein are flexible and may allow both information sources and business systems to produce and request information related to potentially fraudulent conduct, as well as, fraud-related background information.

In some examples, the fraud exchange system can analyze received information from various sources and produce complex event information based on specified criteria. In other examples, the fraud exchange system can act as an aggregator of information and supply that information automatically or on demand to one of more consumers. Aggregation of information can lead to more precise detection of fraudulent activities and fewer false positive alerts. Furthermore, aggregation of information can further result in faster possessing of information by the consumer systems, relieving them of some of the computational burden.

The fraud exchange system described herein is vendor and system agnostic and can allow for communication across different sectors of industry, including banking, insurance, government, law enforcement and brokerage sectors. Various examples of the fraud exchange systems further allow for institutions to implement “best-of-breed” fraud detection systems at the entity level, without inhibiting the free flow of communication and reducing efficiencies. Centralized aspects of the fraud exchange system allow for standardizing and ensuring compliance with strict security protocols and allow for institutions to securely exchange highly sensitive information. Furthermore, aspects of the systems disclosed herein are scalable and allow for integration of additional producers and/or consumers, without significant changes to the system architecture.

The information sources and processes disclosed herein target a wide variety of potentially fraudulent activity. A non-limiting list of the categories of fraudulent activity to that may be investigated using these systems and methods includes deposit account fraud, check fraud, ACH fraud, ATM fraud, debit card fraud, credit card fraud, check kiting, employee fraud, health care fraud, identity theft, mortgage fraud, money laundering, collusive behavior, paperhanging, account takeovers, unauthorized and unsecure access, online fraud, phishing and Trojan attacks, application fraud and bust-out fraud. Other categories of fraudulent activities may be addressed according to various examples. Thus, examples are not limited to activities belonging to particular categories or possessing particular attributes.

According to one aspect, a system for managing and enabling communication of information potentially pertinent to identifying fraudulent activity is provided. The system includes a memory storing a plurality of data points identified as pertinent to potentially fraudulent activity, the plurality of data points including a first data point received from a first source system and a second data point received from a second source system different than the first source system. The system further includes at least one processor coupled to the memory, a producer interface, executed by the at least one processor and configured to receive, from a plurality of source systems, requests to store the plurality of data points, the plurality of source systems including the first source system and the second source system. The system further includes a fraud exchange engine executed by the at least one processor and configured to perform an analysis of the plurality of data points including the first data point and the second data point to produce at least one relational data point, wherein the relational data point is stored in the memory. Additionally the system includes a consumer interface executed by the at least one processor and configured to receive, from at least one target system, a request to retrieve at least one of a set of the plurality of data points and the at least one relational data point.

In the system, the analysis performed by the fraud exchange engine of the first data point and the second data point includes at least one of accumulating, aggregating, filtering, trending and adjusting. In addition, the fraud exchange engine may be configured to produce the at least one relational data point in response to performing the analysis and determining association criteria shared by the first data point and the second data point. Further, the fraud exchange engine may be configured to perform trending of the first data point and the second data point into the at least one relational data point in response to performing the analysis and determining a trend of behavior shared by the first data point and the second data point. Moreover, the fraud exchange engine may be configured to adjust a summary of at least one of the plurality of data points stored in the memory in response to receiving at least one of the first data point and the second data point.

In the system, the consumer interface may be further configured to receive, from the at least one target system, a request to subscribe to a second set of data points, the second set of data points including at least one of all data points, a set of enumerated data points, a set of relational data points and a set of data points based on association criteria, wherein a subscription associating the at least one target system with the set of data points is stored into the memory, in response to receiving the request. Further, where the second set of data points includes the first data point and the second data point, the first data point and the second data point represent a different activity, and the fraud exchange engine is further configured to issue, to the at least one target system, a first message corresponding to the first data point and a second message corresponding to the second data point. Additionally, where the second set of data points includes the first data point and the second data point, the first data point and the second data point represent a same activity, and the fraud exchange engine is further configured to issue a first message corresponding to the first data point and the second data point.

In the system, the fraud exchange engine may be further configured to issue a message corresponding to the at least one relational data point after performing the analysis of the first data point and the second data point and producing the at least one relational data point. In addition, the consumer interface may be further configured to receive, from an agent system, a request to retrieve at least one of a second set of the plurality of data points and the at least one relational data point. Further, the consumer interface may be configured to communicate to the at least one target system, at least one of the set of data points and the at least one relational data point in response to the request from the at least one target system. Additionally, the consumer interface may be configured to receive, from a third source system, a request to retrieve at least one of a second set of data points and the at least one relational data point.

In the system, the producer interface may be configured to receive, from the at least one target system, a request to store at least one of a second set of data points and the at least one relational data point. Further, the producer interface may be configured to receive, from at least one source system, at least one assertion regarding at least one of an identity, an attribute, and an entitlement of a subject. The at least one assertion received by producer interface may be based on SAML protocol. Moreover, the consumer interface may be configured to receive a request to generate an assertion about a subject based on at least one of a second set of data points and the at least one relational data point.

According to another aspect, a computer implemented method for managing and enabling communication of information potentially pertinent to identifying fraudulent activity is provided. The method includes the act of receiving, by a computer, a plurality of data points potentially pertinent to identifying fraudulent activity from a plurality of source systems, the plurality of data points including a first data point received from a first source system and a second data point received from a second source system different than the first source system, the plurality of source systems including the first source system and the second source system. The method further includes the acts of storing, by the computer, the plurality of data points in memory, performing an analysis of the plurality of data points including the first data point and the second data point to produce at least one relational data point, storing, by the computer, the at least one relational data point in the memory, and receiving, by the computer, from at least one target system, a request to retrieve at least one of a set of data points and the at least one relational data point.

In the method, the act of performing an analysis of the first data point and the second data point may further includes performing at least one of accumulating, aggregating, trending, filtering and adjusting. In addition, the act of performing the analysis to produce the relational data point may be performed in response to determining association criteria shared by the first data point and the second data point. Further, the act of trending the first data point and the second data point to produce the at least one relational data point may be performed in response to determining a trend of behavior common to the first data point and the second data point. Moreover, the act of performing the analysis of the first data point and the second data point may include adjusting a summary of at least one data point stored in the memory in response to receiving at least one of the first data point and the second data point.

According to another aspect, the method may further include the acts of receiving, from the at least one target system, a request to subscribe to a set of data points, the set of data points including at least one of all data points, a set of enumerated data points, a set of relational data points and a set of data points based on an association criteria, and storing, responsive to receiving the request, a subscription associating the at least one target system with the set of data points. Further, where the set of data points includes the first data point and the second data point, the first data point and the second data point pertinent to a different activity, and the method may further includes the act of issuing, to the at least one target system, a first message corresponding to the first data point and a second message corresponding to the second data point. In addition, where the set of data points includes the first data point and the second data point, the first data point and the second data point pertinent to a same activity, and the method may further include the act of issuing, to the at least one target system, a first message corresponding to the first data point and the second data point.

According to another aspect, the method may further include the act of issuing, to the at least one target system, a message corresponding to the at least one relational data point after performing the analysis of the first data point and the second data point and producing the at least one relational data point. In addition, the method may further include the acts of receiving, from at least one of the plurality of source systems, at least one assertion regarding at least one of an identity, an attribute, and an entitlement of a subject, and storing the at least one assertion in the memory. Further, the act of receiving the at least one assertion may include receiving at least one assertion based on SAML protocol. Moreover, the method, may further includes the acts of receiving a request to generate an assertion about a subject from the at least one target system, and generating the assertion based on at least one of a second set of data points and the at least one relational, in response to receiving the request. In addition, the method may further include communicating to the at least one target system, at least one of the set of data points and the at least one relational data point, in response to receiving the request from the at least one target system.

According to another aspect, a non-transitory computer readable medium is provided. The computer readable medium has stored thereon sequences of instruction for managing information potentially pertinent to identifying fraudulent activity. The instructions may cause the at least one processor to receive a plurality of data points potentially pertinent to identifying fraudulent activity from a plurality of source systems, the plurality of data points including a first data point received from a first source system and a second data point received from a second source system different than the first source system, store, by a computer, the plurality of data points in memory, perform an analysis of the plurality of data points including the first data point and the second data point to produce at least one relational data point, store, by the computer, the at least one relational data point in memory, and receive, by the computer, from at least one target system, a request to retrieve at least one of a set of data points and the at least one relational data point.

The instructions may cause the at least one processor to perform the analysis of the first data point and the second data point, the analysis further includes at least one of accumulating, aggregating, trending, filtering and adjusting. In addition, the instructions cause the at least one processor to produce the at least one relational data point in response to determining association criteria shared by the first data point and the second data point.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example. References to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example. In addition, it is to be appreciated that activities deemed as potentially fraudulent, or the instruments or items used to conduct these potentially fraudulent activities, may be referred to herein as “suspect” and activities deemed non-fraudulent, and any instruments or items associated therewith, may be referred to herein as “valid,” “genuine” or “authentic.”

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the invention. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram of one example of a system for managing and enabling communication of information potentially pertinent to identifying fraudulent activity within a network;

FIG. 2 is a block diagram of one example of a computer system that may be used to perform processes and functions disclosed herein;

FIG. 3 is a flow diagram of a method for managing and enabling communication of information potentially pertinent to identifying fraudulent activity; and

FIG. 4 is an exemplary illustration of a system for managing and enabling communication of information potentially pertinent to identifying fraudulent activity.

### DETAILED DESCRIPTION

As described above, typical fraud detection systems are system to system specific and are generally unable to share information directly with other systems without customized interfaces or human interaction. Accordingly, there is a need for a comprehensive system of fraud detection that incorporates information from more than one source of information. Aspects and examples disclosed herein relate to systems and processes for managing and enabling communication of information potentially pertinent to identifying fraudulent activity. Processes and systems in accord with some examples include a fraud exchange system that receives data points from one or more sources of information. For example, sources of information may be sources of reference information, transaction information sources, or fraudulent activity detection sources. Information or data points received from these sources may be indicative of fraudulent behavior, indicative of authentic or genuine behavior or may be neutral, such as reference, background, or transactional information. Information received from one or more source systems may also be in raw or processed data and may be in the form of a data point, an event, an alert, an assertion or a claim. An event may be any occurrence that may be pertinent to identifying fraudulent activity. According to some embodiments, the information from one or more sources is received at a producer interface and stored in a data storage system.

Processes and systems in accord with some examples may be configured to perform an analysis of the data points received from one or more sources and produce a relational data point. According to some examples, the analysis may include accumulating, aggregating, relating, and/or trending one or more data points. In one example, the analyses of the one or more of the data points based on association criteria shared by the received data points. In other examples, a summary may be created based on one or more of the received data points. In at least one example, the summary can be adjusted based on one or more of data points subsequently received.

Processes and systems in accord with some examples may be configured to receive requests from one or more business systems to transmit data points retrieved from the data storage system. For example, business systems may be information processors or aggregators such as ACH or wire transfer facilities, customer record management systems or check management systems. A set of the data points may be transmitted to one or more business systems in response to the request received from one of the business systems.

In some examples, the information source systems and the business systems may be within the same network of systems. In examples involving the financial sector, one or more data points may be produced by one financial institution, transmitted to the fraud exchange and requested by another financial institution. In some examples, the information source systems and the business systems can be different types of entities, such as financial institutions and fraud detection systems. Furthermore, information source systems and business systems can be in different industry sectors, such as law enforcement systems and financial systems.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### System of Managing Fraudulent Activity

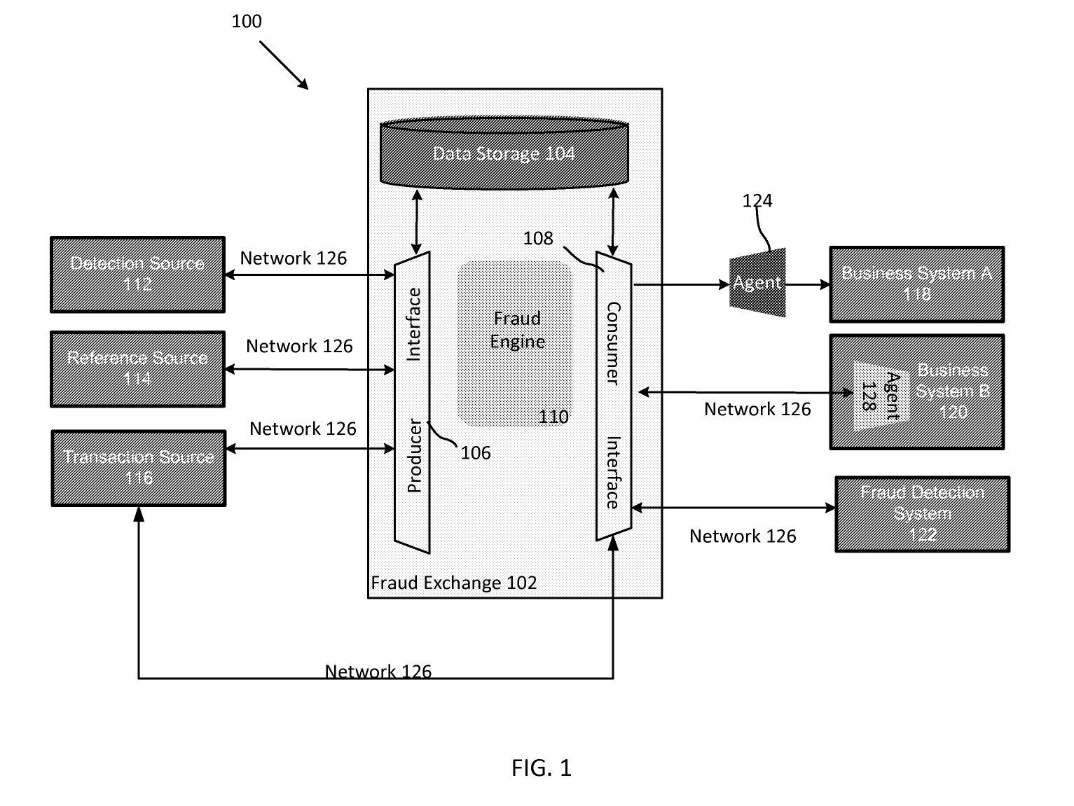

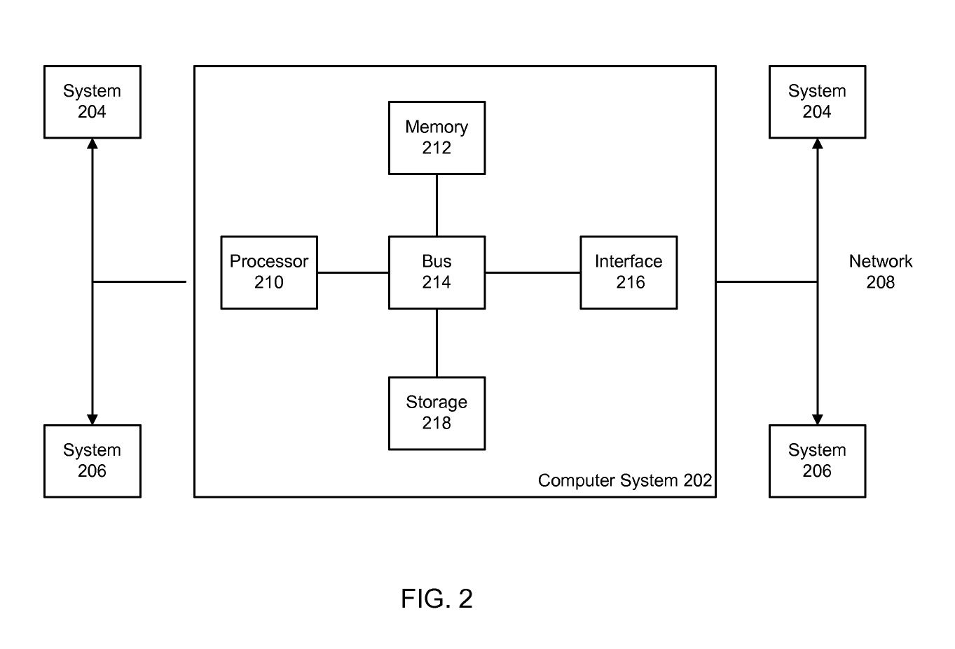

FIG. 1 includes a system 100 for managing and enabling communication of information potentially pertinent to identifying fraudulent activity. According to various examples, the system 100 is implemented using one or more computer systems, such as the distributed computer system 200 discussed below with regard to FIG. 2. Thus, examples of the system 100 include a variety of hardware and software components configured to perform the functions described herein and examples are not limited to a particular hardware component, software component or a particular combination thereof.

As illustrated in FIG. 1, the logical and physical components of the system 100 include a fraud exchange 102, information source systems 112, 114, 116, an agent system 124, business systems 118 and 120, and a fraud detection system 122. As shown, the information sources include a detection source 112, a reference source 114 and a transaction source 116. The detection source 112 can be a producer of risk or fraud related information, for example, an IT security system, a risk-based decision making system, a check fraud detection system, an identity proofing provider, or an identity theft detection system. The reference source 114 may be a producer of reference, background check or identification information, for example, for an individual or an entity. The transaction source 116 may be a provider of transactional information, for example, electronic commerce provider, a credit card transaction processor, or a payment solution provider.

The business systems 118 and 120, the fraud detection system 122 and the information source systems 112, 114 and 116 are coupled to, and can exchange data with, the fraud exchange 102 via the network 126. The network 126 may include any communication network through which computer systems may exchange (i.e. send or receive) information. For example, the network 126 may be a public network, such as the internet, and may include other public or private networks such as LANs, WANs, VAN (value added network), extranets and intranets.

The fraud exchange 102 includes a data storage 104, a producer interface 106, a consumer interface 108, and a fraud exchange engine 110. In the example shown in FIG. 1, the information sources 112, 114 and 116 communicate with the fraud exchange 102 via the producer interface 106. These communications may include data points received from the information source systems 112, 114 and 116 that is potentially pertinent to identifying fraudulent activity. Further, in the example of FIG. 1, the fraud detection system 122 and 118 and 120 communicate with the fraud exchange 102 via the consumer interface 108. Further methods and techniques of communication are described below with regard to communication of business information between two electronic devices over a network without human intervention.

In some examples, the producer interface 106 and the consumer interface 108 can be executed as an Application Programming Interface (API). API is an interface implemented by a software program to enable interaction with other software programs. APIs can provide one or more utilities and enable communication of a defined set of request messages and defines the structure of response messages. However, as explained further below, various techniques and protocols for communicating information may be used without departing from the scope of the examples disclosed herein.

As shown in FIG. 1, the system 100 is designed as “hub and spoke,” with the fraud exchange 102 as a central element or the “hub” and the information sources and the business systems as the peripheral elements or the “spokes.” However, the design of the system for managing information indicative of potentially fraudulent activity can be formed using other approaches. For example, some or all of the business systems and the information sources can be linked or chained to together.

Continuing the example of FIG. 1, the producer interface 106 and the consumer interface 108 communicate with the data storage 104. These communications may include information, such as the information provided by the information sources 112,114 and 116. The data storage 104 depicted in FIG. 1 includes components that store and retrieve information. Some of the methods and techniques of storing and retrieving information from the data storage are described below with reference to computer system 202 and FIG. 2. In general, the information may include any information associated with any activity recorded by the information sources 112, 114 and 116, the business systems 118 and 120 or the fraud detection system 122. For example, information may include reference information, transaction information, fraud detection information, fraud event information, fraud alert information, individual or entity profile information, or case investigation information. In at least one example, the information received by the fraud exchange can be generated by information sources 112, 114 and 116, by the fraud detection system 122 or by the business systems 118 and 120.

In one example, information includes an identifier of the system reporting an event or a data point, one or more categories of the data point or the event being reported, one or more identifiers of the reason that the event or the data point was reported, a timestamp and one or more identifiers of the longevity of the event or data point. Information may be indicative of fraud activity, may be indicative of authentic or genuine activity or be neutrally oriented. In some examples, the information can include raw data or information processed by the information sources 112, 114 or 116.

In some examples, the reason identifiers are categorized into fraud categories that indicate one or more categories of potentially fraudulent activity. Received information may have any number of reason identifiers which could indicate different types of fraud. For example, reason identifiers belonging to the deposit fraud category include reason identifiers that indicate activity involving deposits with characteristics that fall outside an established pattern, transactions conducted in suspect locations, accounts causing the financial institution to suffer increased exposure, accounts exhibiting an increasing negative balance collected, accounts with a large amount of activity given the length of time they have been open, accounts associated with large payments, accounts associated with a new branch, accounts with previously returned checks, accounts exhibiting an increase in the rate of returned checks, accounts associated with previous alerts and accounts with an unusual exposure.

The information may further include qualitative information relating to the received information. For example, the qualitative information can include a confidence level of the accuracy of the information, a risk score for a commercial or an individual entity, and an analysis of the significance of an event. The qualitative information may be input by one or more of the information sources 112, 114, 116 or alternately may be calculated by the fraud exchange 102 based on various inputs from the information sources. For example, the received data points can include information or assertions about the respective source of the information and a claim of the information source's reliability in identifying fraud.

The information received by the fraud exchange 102 may further include one or more designated recipients of the information such as the business systems 118 and 120 or other actors suited to receive the information. Designated recipients can be determined based on relevancy or level of access for the business system. For example, information identifying fraudulent checks is intended for business systems that process negotiated instruments. Furthermore, communication of information about the actors related to the fraudulent checks may be needed as part of compliance with due diligence and financial regulation requirements. In one example, the information further includes various possible or default actions the business systems can and/or should take. For example, actions may include stopping payment on the fraudulent check.

Information received at the producer interface 106, including data points, event information, transaction information, reference information and the related qualitative information may be stored in the data storage 104 in any logical construction capable of storing information on a computer readable medium. For example, logical structures may include, among other structures, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

Continuing the example of FIG. 1, the fraud exchange engine 110 communicates with the data storage 104, the producer interface 106 and the consumer interface 108. Alternatively, the producer interface 106 and the consumer interface 108 can communicate with the fraud exchange engine 110, which can store the received information in the data storage 104. In another embodiment (not shown), the fraud exchange engine 110 is executed outside of the fraud exchange 102. In this embodiment, the fraud exchange engine 110 communicates with the consumer interface 108 to receive incoming data points and uses the producer interface to output relational data points and alerts to the one or more business systems 118 and 120 and the fraud detection system 122.

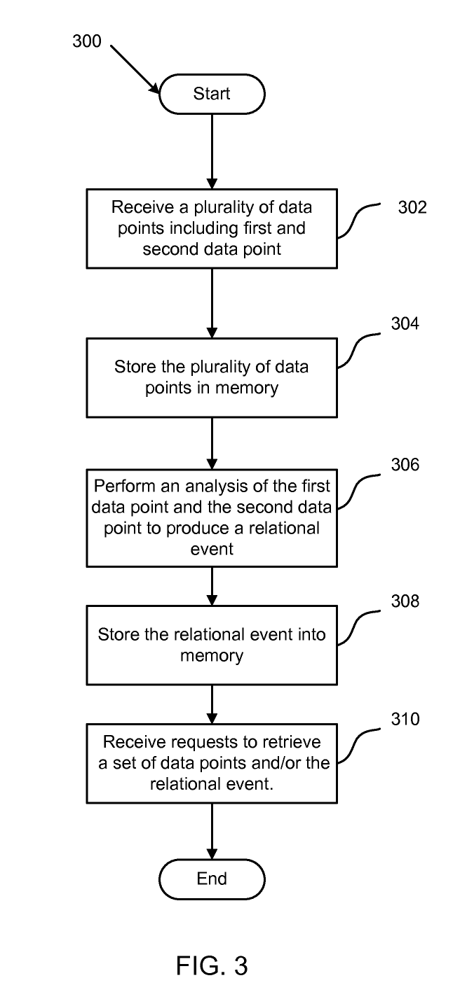

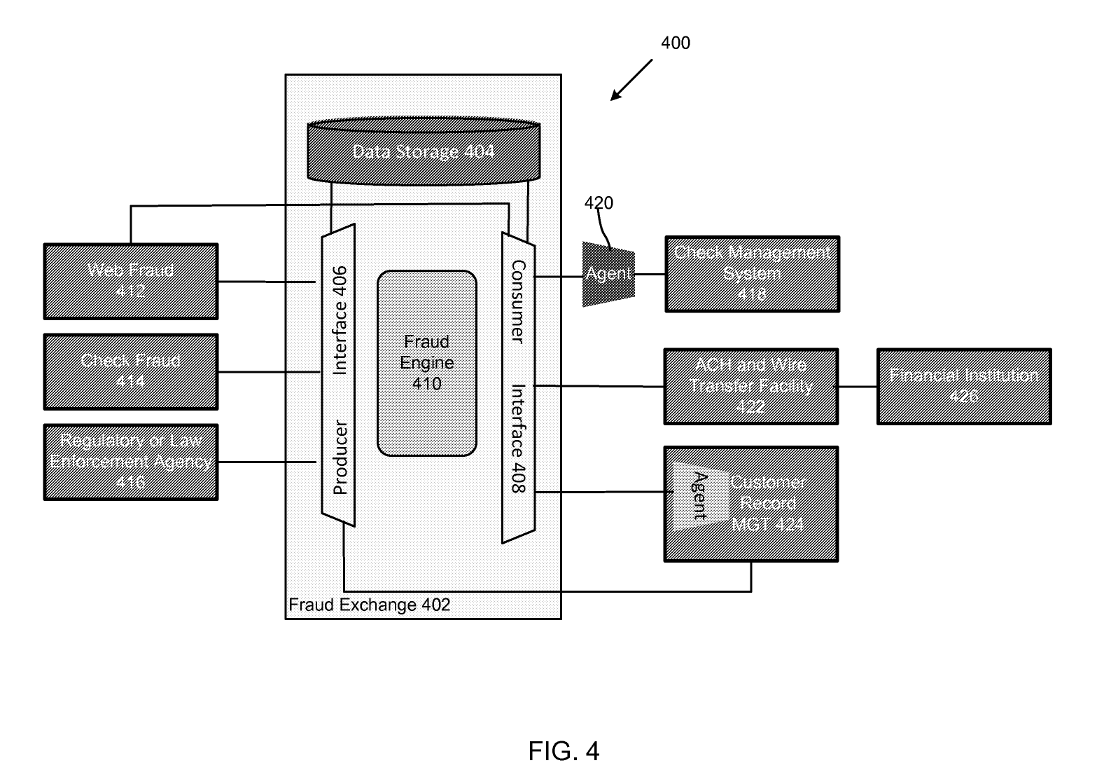

The fraud exchange engine 110 may perform a variety of data processing activities, such as the data processing activities discussed further below with regard to FIG. 3-4. To perform data processing activities, the fraud exchange engine 110 may access information stored in the data storage 104. Data processing methods and techniques that are performed by the fraud exchange engine 110 can be executed by one or more processors, as further described with reference to FIG. 2. Some of the data processing activities can include Complex Event Processing (CEP). CEP systems receive numerous data points and based on these received data points in real-time deduce a complex event. CEP systems may use one or more of the following techniques, including but not limited to pattern detection, event abstraction, modeling data point hierarchies, detecting relationships between data points, abstracting data point-driven processes, as well as other techniques.

Some of the data processing activities include implementing policies for renewing, refreshing and rebroadcasting received data points. For example, when a data point containing an identifier for the longevity expires, the fraud exchange engine 110 may perform a check with the fraud information source from which the event was obtained to update the related data points. In one example, the fraud exchange engine 110 may periodically perform refreshing functions by checking whether new data points are available from one or more information sources. If new data points are available, the consumer interface 108 may rebroadcast the data points to one or more of the business systems. Other data processing activities can include a back up and recovery functions for the data points and the related identifiers stored in the data storage 104.

Some of the data processing activities can include mapping or matching of received information to related information stored in the data storage 104. Any methods or techniques of data integration can be used and may include methods of performing data driven mapping or semantic mapping by the fraud exchange engine 110 to the related information stored in the data storage 104. For example, information relating to an individual may mapped by to information stored in the data storage 104 based on the individual's Social Security number. Some of the data processing activities can further include accumulating one or more data points suggesting fraudulent behavior received from information sources until a threshold number of data points is received. For example, a third attempt to incorrectly log into an online banking system from an unknown terminal can result in a suspicion hold to be placed on the account.

Some of the data processing activities can further include aggregating data points from one or more information sources 112, 114 and 116 into a relational data point based on association criteria shared by both data points. In one example, the producer interface 106 may receive one data point from one information source 112 and another data point from another information source 114. In this example, while the individual data points may not be indicative of fraudulent activity independently, a conclusion reached by combining the data points may be indicative of fraud. Similarly, the individual data points may be indicative of fraud, but the conclusion reached by combining the data points may reduce the likelihood of fraud. In one example, the subsequently received data points reducing the likelihood of fraud can be part of a false-positive mitigation trend or pattern.

The fraud exchange engine 110 may analyze the received data points to determine whether the one or more data points meet the association criteria. Subsequently, if the data points meet the association criteria, the fraud exchange engine 110 may combine the individual data points to produce the relational data point. As a result of producing the relational data point, the consumer interface 108 may issue a message corresponding to the relational data point to one or more business systems. The association criteria can be stored in the data storage 104 and retrieved for analysis by the fraud exchange engine 110.

The association criteria can be met based on, for example, causality, membership, timing or combinations thereof. Causality indicates one data point triggering another data point. For example, a determination that a check is fraudulent can trigger the check to be placed on hold and can trigger a notice of suspicion to be placed on the individual cashing the check. In another example, timing can be detected based on data points occurring based on a definable time frame. Typical causality relationship can be stored in the data storage 104 and can be accessed by the fraud exchange engine 110. For example, an investigation of a particular spoofing attack on a network system can generate a request for all data points occurring within the time period of the suspected attack.

In one example, membership can be detected based on data points belonging to a unifying group, a common actor, or a category of data points. The common actor can be any acting individual or entity. For example, an actor can be an individual customer, an account holder, a system or a website user, an employee of another actor, or an individual suspected of fraudulent activities. The actor can also be an entity, such as, a financial institution, a corporate organization, a government or regulatory agency, or a law enforcement agency. The actor can be a producer or a consumer of potentially fraudulent information or any third party associated with the consumer of potentially fraudulent information. Information about the actor can be stored in the data storage 104 and can be accessed by the fraud exchange engine 110.

In another example, membership can be determined based on a type of fraudulent activity. For example, the fraudulent activity may relate to account or profile management in a financial institution, such as account closing, change of address, logging into an account from an unknown terminal. In another example, the membership can be determined based on a single instrument, such as relation to a potentially fraudulent check. In a further example, membership can be based on a single geographic area, for example by a zip code, city, state, etc. However, any type of membership can be defined by the system to meet the association criteria.

Further data processing activities can include analyses of trends or patterns of data points by comparing the received data points to a scenario database. The scenario database may be part of the data storage 104 and may be accessed by the fraud exchange engine 110. The scenario database may contain patterns and the related categories of fraudulent behavior. If the pattern matches a particular fraudulent scenario, the fraud exchange engine 110 may also produce a relational data point corresponding to the one or more matching data points. Similarly, the pattern of data points may reduce the likelihood of a potentially fraudulent scenario by failing to match one or more data points in the pattern. In one example, this pattern of data points can be part of a false-positive mitigation strategy. As the result of producing the relational data point, the consumer interface 108 may issue an alert corresponding to the relational data point to one or more business systems.

Other data processing activities can include determination of qualitative data, as described above with respect to assessment of the risk score. In one example, the fraud exchange engine 110 may determine the risk score for an actor that represents the likelihood of fraud associated with that actor. Alternatively, the information sources may determine and provide the risk score, which can be stored with the received data point. In one example, the risk score is based on data points that identify characteristics and behaviors which are similar to previously identified commercial or individual fraudsters. These behaviors and characteristics can be stored in the data storage 104 and can be accessed by the fraud exchange engine 110. In one example, a higher risk score could indicate a higher likelihood of fraud, and a lower risk score could indicate a lower likelihood of fraud.

Other data processing activities can include profile creation and ongoing profile management for an actor. The fraud exchange 102 may accumulate information about the actor based on any received data points and any other historical, reference, or background information available to the fraud exchange from the information sources or the business systems. Information accumulated by the fraud exchange 102 can be stored in the data storage 104 and can be accessed by the fraud exchange engine 110. For example, the fraud exchange may use information sources, such as, identity federation or identity and access management systems to create an assembled profile for a particular actor. A business system requesting information relating to a particular actor may receive the actor profile, along with a risk score and any potentially pertinent historical fraudulent information.

According to one example, the fraud exchange engine 110 adjusts a summary created from one or more data points received or determined, as a result of subsequently receiving and processing one or more data points. In the examples relating to a received or determined risk score, the data points received could result in a higher or lower risk score. Some data points could indicate a higher risk score based on a number of indicators, while other data points could indicate a lower risk score based on other indicators. The fraud exchange engine 110 can determine which data points have more weight in determining whether to increase or decrease the risk score. The fraud exchange engine 110 may also adjust the summary, such as the risk score, based on a passage of time. For example, the risk score may be decreased if the fraud exchange receives no fraudulent data points associated with a particular actor within a five year time period.

According to some examples, the fraud exchange 102 can act as a system of record for information received from any of the information sources. The fraud exchange 102 can receive one or more data points from multiple source systems. The one or more data points may describe the same or substantially similar events, background information or reference information. The fraud exchange 102 may consolidate these data points to create a unified source of information. In some examples, the fraud exchange system may perform data matching on the data points received at the producer interface to the related data stored in the data storage 104. According to some examples, the fraud exchange engine 110 may execute various methods of data normalization and/or data standardization to create the unified source of information. The fraud exchange engine 110 may use a rules-based approach to consolidating the received data points in the data storage 104. The rules-based approach may include one or more rules that can be based on the type or the identity of the information source and the qualitative information associated with the data points. In at least one example, the data points received at the fraud exchange 102 for consolidating may include conflicting data points. The fraud exchange 102 may consolidate these conflicting data points from multiple source systems by determining the validity of each received data point.

Continuing the example of FIG. 1, the consumer interface 108 communicates information to the consumers of information, such as the business systems 118, 120 and fraud detection system 122. The information may be in the form of one or more data points, summaries, events, assertions, claims, messages, alerts or relational data points. The consumers may receive information either actively or passively. In passive mode, the consumers may query to the fraud exchange 102 intermittently or based on occurrence of specific events at the business system. The query may be performed based on specified criteria. The fraud exchange 102 may perform a search for information matching the specified criteria. The consumers may also send one or more requests to the fraud exchange 102 via the consumer interface 108 for any information stored in the data storage 104. For example, when a transfer is requested by an external system, a wire transfer facility send a request to the fraud exchange 102 for all data points or events associated with the related accounts that match a specific category of fraud. The fraud exchange engine 110 may perform the search, as soon as the request is received and respond to the consumer as soon as the search is concluded. Alternatively the fraud exchange engine 110 may batch requests and perform the search after a passage of time. In another example, the search may be performed as soon as the request is received, and the communication of the information found can be performed after a passage of time.

According to some embodiments, the consumers in active mode can actively listen to all or a filtered set of information or relational data points meeting a certain criteria and may take a variety of actions in response to the received data points. The data points may be filtered or selected by the fraud exchange engine 110 based on specified association criteria. For example, communicate all information relating to a specific actor, a specific category and/or a specific reason identifier. The consumers in active mode may communicate a subscription request for the filtered set of information, as further described below.

According to other examples, the fraud exchange 102 may not analyze the data points received. Instead, the fraud exchange 102 may communicate information to one or more of the business systems automatically or as soon as, or shortly after, the information is received by the fraud exchange 102. The information can be the data points received, a message and/or an alert relating to the data point received. For example, the fraud exchange 102 can receive information identifying a fraudulent check. This information, along with a message is automatically communicated to the fraud detection system 122.

According to other examples, the fraud exchange 102 may function as a system of real-time interdiction. In this example, the fraud exchange 102 may receive one or more data points from one or more information systems, 112, 114 or 116 or business systems 118, 120, 122 indicating potentially fraudulent activity. The fraud exchange engine 110 may perform an analysis of the data points and determine that potentially fraudulent activity is taking place. The fraud exchange 102, via the consumer interface 108 may issue one or more messages or alerts to one or more of the business systems 118, 120, 122 that may alter or interdict a process executing on the or more of the business systems.

In one example, the consumers in active mode may communicate through the agent 124. As shown in FIG. 1, agent 124 resides outside of the business system 118. The agent 124 may analyze outgoing data points or events from the consumer interface 108 on behalf one or more of business systems and identify events that may be relevant to the receiving business system. In one embodiment, the agent 124 aggregates and/or filters events before communicating to the one or more businesses systems based on preferences, and/or a subscription created by the respective business systems. The agent 124 may also determine whether the business system requesting the information has the needed authorization to access the requested information.

In some embodiments, the consumers may send a request to the fraud exchange 102 to subscribe to a set of events. The set of events may include all or some of the data points, events and/or relational data points. The fraud exchange 102 may receive the subscription request through the consumer interface 108. The subscription request may subsequently be stored as a subscription associating the requesting consumer with the requested set of events in the data storage 104.

In another example, an agent can be part of the business system, as shown in FIG. 1 with regards to agent 128 and business system 120. The agent 128 can block transactions at the business system 120 based on the messages received from the consumer interface 108. For example, the fraud exchange 102 may issue a message to a teller platform that a check received by a teller at a financial institution is fraudulent. The agent, part of the teller platform, can prevent the teller platform from honoring the received check.

According to some examples, the fraud exchange 102 can follow a set of access control policies for each consumer of information. Access control policies can determine based on information relating to the business systems whether to authorize the business system access to the requested information. Access control policies may be based on secure communication protocols further described below.

According to some examples, information sources can act as consumers of information, events, relational data points, alerts, messages, assertions or claims. As shown in FIG. 1, fraud detection system 122 acts as a consumer of information and receives information from the consumer interface 108. Similarly, in at least one example, the business systems can act as producers of information indicating fraudulent activity and communicate with the producer interface 106.

Continuing the example of FIG. 1, communications between the information sources and the producer interface 106, as well as, communications between the consumers and the consumer interface 108 may be implemented using messaging and security protocols that allow interoperability of diverse range of systems. In one example, communication messages comply with a communication protocol that is common to the fraud exchange, the information sources and the business systems shown in FIG. 1. The systems described herein may employ any method of communication of business information between two electronic devices over a network without human intervention. For example, methods may include web services, cloud computing services, RosettaNet, EDI, ebXML or any other method that allows communication of electronic business information in an interoperable, secure, and consistent manner. In the system 100, any methods may be used to communicate information, events, data points and requests to the fraud exchange 102, as well as, communicate data points, alerts, events and information from the fraud exchange 102.

For example, any protocol used may define specifications and guidelines for processing, transmitting, receiving, encrypting and structuring the communication message. In one example, the received information may include an envelope, which defines what is in the message and how to process it, a set of encoding rules for expressing instances of application-defined data types, and a convention for representing procedure calls and responses. In one example, upon receiving information from one of the source systems, the fraud exchange 102 may validate the sending system as part of an approved network of systems. The fraud exchange 102 can further verify that the envelop meets defined specification and that the contained information conforms to the agreed guidelines. The system may also convert the received information into any number of formats used by the receiving system to store and process the contained information. The defined protocol can be used for requests from the business systems to the fraud exchange 102 that allow for streamlined integration of the received data directly into the requesting systems.

Because of the sensitive nature of some of the information security protocols can be used for communication between systems. Any number of security protocols may be used that enforce integrity and confidentiality in the communicated messages, for example, the Web Services Secure Exchange (WS-SX) protocol, created by the Organization for the Advancement of Structured Information Standards (OASIS). The security protocol can further allow for exchange and validation of security tokens as part of the communicated message. Security tokens can be in any compatible security token format, such as, Security Assertion Markup Language (SAML), Kerberos, and X.509, as well as, other known security token formats.

In one example, a secure communication can be performed by first establishing secure session between an identity provider and a relying party. In this example, the fraud exchange is the identity provider and the information sources and the business systems are the relying parties. After a secure session is established between the fraud exchange and the relying parties, security tokens are generated by a security provider service. After security tokens are generated, messages are exchanged between systems using the tokens for authentication, authorization, data privacy and data integrity. In addition, the security tokens can further be associated with one or more cryptographic keys. In one example, the keys can be used to sign messages and communicate to the relying party that the security token was validly issued from the security service provider.

In at least one embodiment, secure communications can include assertions transferred from the information sources to the fraud exchange to communicate statements about a subject that the fraud exchange can use to make decisions. These assertions allow communicating entities to make statements regarding identity, attributes, and entitlements of a subject to other entities. For example, SAML assertions within the SAML protocol, developed by OASIS, provides XML-based framework for creating and exchanging security information between online partners. SAML assertions include elements defining authentication, attribution, authorization decisions, and/or user-defined statements.

For example, the detection source 112 can provide a SAML assertion to the fraud exchange 102 that contains statements about the identity of the detection source 112 and authentication of the information communicated by the detection source 112. In another example, the assertions can be about an actor in the detection source 112. The assertions and statements included therein, provided by the detection source 112, can be stored in the data storage 104 and can be further used to determine qualitative data, such as a risk score or other summary information. In one example, the fraud exchange engine system 110 can generate an assertion about a subject based on the information stored in the data storage 104. This assertion can be generated based on a request by one of the consumers received at the consumer interface 108. Further, the assertion can be communicated to one or more of the consumers, such as the business system 118 and 120 and/or the fraud detection system 122.

### Computer System

As discussed above with regard to FIG. 1, various aspects and functions may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions may be practiced. The distributed computer system 200 may include one more computer systems that exchange (i.e. send or receive) information. For example, as illustrated, the distributed computer system 200 includes computer systems 202, 204 and 206. As shown, the computer systems 202, 204 and 206 are interconnected by, and may exchange data through, a communication network 208. The network 208 may include any communication network through which computer systems may exchange data. To exchange data using the network 208, the computer systems 202, 204 and 206 and the network 208 may use various methods, protocols and to standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 202, 204 and 206 may transmit data via the network 208 using a variety of security measures including, for example, TLS, SSL or VPN. While the distributed computer system 200 illustrates three networked computer systems, the distributed computer system 200 is not so limited and may include any number of computer systems and computing devices, networked using any medium and communication protocol.

FIG. 2 illustrates a particular example of a distributed computer system 200 that includes computer system 202, 204 and 206. As illustrated in FIG. 2, the computer system 202 includes a processor 210, a memory 212, a bus 214, an interface 216 and data storage 218. The processor 210 may perform a series of instructions that result in manipulated data. The processor 210 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. The processor 210 is connected to other system components, including one or more memory devices 212, by the bus 214.

The memory 212 may be used for storing programs and data during operation of the computer system 202. Thus, the memory 212 may be a relatively high performance, volatile, random access memory such as a dynamic random access memory (DRAM) or static memory (SRAM). However, the memory 212 may include any device for storing data, such as a disk drive or other non-volatile storage device. Various examples may organize the memory 212 into particularized and, in some cases, unique structures to perform the functions disclosed herein and these data structures may be tailored to store values for particular types of data.

Components of the computer system 202 may be coupled by an interconnection element such as the bus 214. The bus 214 may include one or more physical busses, for example, busses between components that are integrated within a same machine, but may include any communication coupling between system elements including specialized or standard computing bus technologies such as IDE, SCSI, PCI and InfiniBand. Thus, the bus 214 enables communications, such as data and instructions, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and communicate with external entities, such as users and other systems.

The data storage 218 may include a computer readable and writeable nonvolatile (non-transitory) data storage medium in which instructions are stored that define a program or other object that may be executed by the processor 210. The data storage 218 also may include information that is recorded, on or in, the medium, and this information may be processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller may cause data to be read from the nonvolatile recording medium into another memory, such as the memory 212, that allows for faster access to the information by the processor 210 than does the storage medium included in the data storage 218. The memory may be located in the data storage 218 or in the memory 212, however, the processor 210 may manipulate the data within the memory 212, and then copy the data to the storage medium associated with the data storage 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Fraud Exchange Processes

An example of the method implemented by the fraud exchange 102 is illustrated in FIG. 3. In this example, the process 300 includes act of receiving a plurality of data points potentially pertinent to identifying fraudulent activity including a first data point and a second data point, storing, the received data points in memory and performing an analysis of the first data point and the second data point. Process 300 begins at 302.

In act 302, the fraud exchange 102 receives a plurality of data points identified as potentially pertinent to fraudulent activity. According to various examples, the plurality of data points is received at the producer interface 106. The producer interface 106 may receive the data points from one or more information sources, such as information sources 112, 114 and 116. Each received data point at the producer interface 106 may be from a different information source. For example, the first received data point is from information source 112 and the second data point is from information source 114. In some examples, the data points may comprise data points or information as described above. In act 304, the received data points are stored in the data storage 104. In act 306, the fraud exchange engine 110 performs an analysis of the first data point and the second data point to produce a relational data point. In act 308, the produced relational data point is stored in the data storage 104. In act 310, requests to retrieve are received. The request to retrieve could be for a set of data points, the relational data point or both. Process 300 ends at 310.

According to various embodiments, the analyses of the first and second data points to produce the relational data point (in act 306) may include accumulating, aggregating, trending and/or adjusting. In some embodiments, accumulating of the first data point and the second data point may be performed in response to determining association criteria shared by the first data point and the second data point. In some embodiments, aggregating of the first data point and the second data point may be based on meeting association criteria which may be shared by the received data points. The fraud exchange engine 110 may analyze the received data points to determine whether the one or more data points meet the association criteria. In one example, the producer interface may receive one data point from one information source and another data point from another information source. In this example, the first data point and the second data point may be related by common membership, causality and/or time.

In some embodiments, accumulating the first and second data points suggesting fraudulent behavior until a threshold number of data points is received. In at least one embodiment, trending of the first and second data point may be performed based on the two data points meeting a pattern of behavior indicating fraudulent activity. In another embodiment, trending of the first and second data point may be performed based on the two data points meeting a pattern of behavior indicating authenticated or genuine activity.

In some embodiments, adjusting of a summary of at least one data point stored in the memory may be performed in response to receiving at least one of the first data point and the second data point. In one example, the summary of a data point may be a risk score associated with the received information. The summary, representing the risk score, can be adjusted by either increasing or decreasing depending on the received data point the effect on the risk score. In the examples relating to system of record, the summary may be adjusted based on subsequently received data points which may contain conflicting information to the previously received and stored data points. In another example, the summary may be adjusted based on subsequently received data points that indicate a previously false positive determination of fraud.

According to various embodiments, the stored data points (in act 304) and/or the relational data point are communicated to one or more business systems (act 310). The communication to the business system may be in the form of an alert, an event, a relational data point, a data point, an assertion or a claim. In one example, the alert may correspond to the relational data point after aggregating the first data point and the second data point into the relational data point. In another example, the alert may correspond to the one or more received data points at the fraud exchange 102. In the embodiment, where the first and the second received data points correspond to a different potentially fraudulent activity, the fraud exchange 102 communicates separate alerts for each received data point. For example, a first alert corresponding to the first data point and a second alert corresponding to the second data point. In the embodiments where the first and the second received data points correspond to a similar or same fraudulent activity, the fraud exchange 102 communicates one alert corresponding to the first and the second data point.

According to some embodiments, the one or more business systems are configured to respond to the received data points, events or alerts in various ways, depending on the type of business system and the type of data point, event or alert received. For example, as the result of receiving the data point or alert a business system may suspend, cancel or release a transaction. The response at the business system may be processed in real-time, for example, as the data point, event or alert is received. Alternatively, the response at the business system may be processed in batches, for example intermittently or as soon as a threshold number of data points is received.

In one embodiment, the fraud exchange 102 may receive a request to subscribe to a set of events from one or more business systems. The set of events may include one or more of all the data points received from the information sources. The set of the events may also include a set of enumerated data points specified by the business system. The enumeration may be based on the information described above, such as category of the data point being reported, the category of the event being reported, or the identifier of the reason that the event was reported. Furthermore, the set of events may also include a set of relational data points. The set of events may be any combination of the events, data points and event information as described above. In response to receiving the request for the subscription from the business systems, the fraud exchange 102 may store a subscription associating the business system with the set of events.

Process 300 depicts one particular sequence of acts in a particular example. The acts included in process 300 may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. In addition, as discussed above, in at least one example, the acts are performed on a particular, specially configured machine, namely a computer system configured according to the examples disclosed herein.

### Exemplary Usage Scenarios

Various examples employ a fraud exchange to perform a variety of beneficial processes. FIG. 4 illustrates one example of a system 400 for managing potentially fraudulent information and for performing such processes. As shown, the system 400 includes a fraud exchange 402, one or more fraud information source systems 412, 414, 416, and one or more business systems 418, 422, 424. The fraud exchange 402 includes data storage 404, a producer interface 406, a consumer interface 408, and a fraud exchange engine 410. In the example shown in FIG. 4, fraud information sources, such as, a web fraud detection system 412, a check fraud detection system 414 and financial regulatory agencies 416 communicate with the fraud exchange 402 via the producer interface 406. In the example of FIG. 4, the business systems, such as customer record management systems 424, an ACH or wire transfer facility 422 and check management system 418 communicate with the fraud exchange 402 via the consumer interface 408. These communications may include information requests for a set of data points, one or more relational data points and/or alerts triggered by the received data points. Information received from the consumer interface 408, may be communicated to a financial institution 426.

The fraud information sources produce one or more data points indicating fraudulent or genuine activity to the fraud exchange 402. In one example, the web fraud detection system 412 may implement a number of services that generate one or more data points, including user identity verification, monitoring of online transactions, account management or banking/payment transactions, fraud protection against phishing and Trojan attacks, and shared data repository of fraud profiles or other cybercriminal activity. The events indicating fraudulent activity generated by these services may include failed attempts at user identification verification, unanticipated or high risk online transactions, phishing or Trojan attack attempts and/or new fraud profile generation.

In another example, the check fraud detection system 414 may identify counterfeits, forgeries and alterations of checks using fraud detection systems that integrate image-based detection with transactional history. For example, fraud detection systems use recognition engines to identify fraudulent images using check stock validation, signature detection, and amount alteration. The transaction history may use customer profile database that automatically builds customer and check profiles from check images. The events indicating fraudulent activity can be generated by the check fraud detection system 414 when the system detects a counterfeit, forged or altered check. The check fraud detection system 414 may have a number of member organizations that provide check information to build a database of the transactional history of suspicious checks.

In another example, regulatory or government agencies 416 can also act as sources of information. For example, the Financial Crimes Enforcement Network (FinCEN) is a bureau of the United States Department of the Treasury that collects and analyzes information about financial transactions in order to combat fraudulent activity by collecting reports of suspicious activity from money services businesses (MSB). A transaction must be reported if the MSB knows, suspects or has reason to suspect that the transaction (or a pattern of transactions of which the transaction is a part), involves funds derived from illegal activity or is intended or conducted in order to hide or disguise funds or assets derived from illegal activity, or is designed to evade the requirements of the Bank Secrecy Act, whether through structuring or other means. Furthermore, the Federal Deposit Insurance Corporation (FDIC) or Office of the Comptroller of the Currency (OCC) can also sends out public alerts for counterfeit checks or other fraudulent instruments that are circulated around the country.

In a further example, law enforcement agencies 416 can also act as sources of information describing fraudulent activity. For example, the FBI's Financial Crimes Section investigates matters relating to fraud, theft, or embezzlement occurring within or against the national or international financial community. Law enforcement agencies may publish a list of suspects to be watched for potential fraudulent activities (also called a “blacklist”). For example, the fraud division of the local police department may publish a list of individuals suspected of money laundering. The Office of Foreign Assets Control (OFAC) of the US Department of the Treasury publishes a list of Specially Designated Nationals (SDNs), whose assets are blocked and U.S. persons are generally prohibited from dealing with them. Similar lists may be published by the local state attorney general and United States Department of Justice.

According to various examples, the fraud information sources can also act as consumers of information indicative of potentially fraudulent activity and communicate with the consumer interface 408. For example, check management system 418 is presented a check and information about the check is communicated to the fraud exchange 402. In this example, the check is subsequently found to be altered. Information about the altered check may be imported into the check fraud detection system 414 and a pattern of check alteration may be created in the check fraud detection system 414 based on the altered check information.

The data points received from one or more fraud information sources may be processed by the fraud exchange 402, which may automatically initiate changes in the procedural flows executed by internal or external systems. According to one example, the fraud exchange 402 may facilitate intra-bank communications, such as those between one financial institution and another financial institution. For example, law enforcement or regulatory agency publishes a list of suspects to be watched for potential money-laundering activities. Bank A may identify a pseudonym being used by a suspect on the list and may communicate this information as an event to fraud exchange 402. The event may include event information identifying the last known geography and pseudonym associated with the suspect. The fraud exchange issues an alert to Bank B that is located within the known geography. Bank B may send a request to fraud exchange 402 to subscribe to any events relating to the suspect. Bank B may also update anti-money laundering (AML) filter.

According to another example, the ACH or wire transfer facility 422 is a computerized facility used by the financial institution 426 to electronically combine, sort, and distribute credits and debits between different banks. In the example where the fraud exchange 402 determines that an ACH or a wire transfer is likely to be fraudulent, the fraud exchange 402 may issue an alert to the ACH facility 422. In this way, ACH facility 422 may take a variety of actions in response to the alert such as preventing the transfer or notifying an external entity, such as the financial institution 426, of the suspect nature of the transfer.

In another example, the check management system 418 responsible for processing a check received from the financial institution 426, requests information relating to the check from the fraud exchange 402. The fraud exchange 402 may determine, for example based on one or more stored events or data points, that the check is potentially fraudulent. The fraud exchange 402 may then issue an alert to the check management system 418 along with any information relating to the check, for example profile information of the person cashing the check. In this example, the check management system 418 may issue a check exception hold, allowing the depository institution to hold processing of the suspect check until further analyses may be conducted. The check exception hold may exceed the typical check hold periods allowed by the depository institution. Subsequently, the fraud exchange 402 may issue another alert to the check management system 418 indicating that the check was validly presented, as the result of receiving an alert from a fraud source clearing the check. In this situation, the check management system 418 may release the held check for further processing, for example, at the financial institution 426.

According to another example, the business systems can act as producers of data points indicating fraudulent activity and communicate with the producer interface 406. In one example customer record management 424 may produce account information, customer information, branch information, employee information and financial transaction information. Other examples of the business systems that act as producers may include financial software systems, payroll systems, and customer relationship management systems. In addition, the business systems may produce an audit trail detailing the date and time of any changes made to the data contained within. Furthermore, the business systems can produce information based on due diligence performed as part of Know Your Customer (KYC) regulations.

In one example, the fraud exchange 402 may also determine which requests for data received from the consumer interface 408 could be indicative of additional fraudulent activity and generate information based on the received request. In the previous example, where the fraud exchange 402 determines that the presented check is potentially fraudulent, based on the received request for information pertaining to the check, the fraud exchange 402 may store information relating to the request as an event in the data storage 404. For example, the event may be the addition of the customer presenting the fraudulent check as a suspect to a case investigating the check. If that same suspect presents a check at financial institution 426, the fraud exchange 402 may issue another alert to the check management system 418 to issue a check exception hold.

According to various examples, the fraud exchange 402 analyzes received requests for data points from one or more business systems in real-time, or as soon as the fraud exchange receives the requests. For example, the business system may detect a user requesting a wire transfer through an external interface. The business system may request information from the fraud exchange about the user and the wire transfer as soon as the request is received and based on the received information may approve or deny the user's request. In this example, because the request from the fraud exchange is returned in real-time, to the user the transaction occurs without interruption.

According to other examples, the business systems may request information that enables the business system to make a risk-based authentication and transaction verification. In the wire transfer example described above, the business system may receive a risk score associated with the transaction that indicates the likelihood that the wire transfer is potentially fraudulent. Based on the received risk score, the business system may determine whether to approve or deny the user's wire transfer.

According to other examples, the risk score may be either increased or decreased based on subsequently received data points. For example, the fraud exchange 402 receives a data point indicating check fraud for an account holder at the financial institution 426 who has been previously investigated for check fraud. Based on this information, the fraud exchange 402 increases the risk score associated with that account holder. The risk score is communicated to the check management system 418 that may prevent another financial institution from cashing a check presented by the same account holder.

In another example, the check management system 418 determines whether to cash an “on-us” check requests and receives a high risk score from the fraud exchange 402 relating to the “on-us” check. The check management system 418 would not typically honor a check with such a high risk score. The high risk score may be determined by the fraud exchange 402 based on data points that relate to timing and serial number of the “on-us” check, suggesting that there is a high risk that the “on-us” check is fraudulent. However, the fraud exchange 402 may also receive one or more data points from the check fraud system 414 that is a signature-matching system about the signature stored with an account at the financial institution 426, the check fraud system 414 can compare the signature on the “on-us” check with the stored signature on the account. These received data points show a good match between the signature on the “on-us” check and the expected signature. As the result, the fraud exchange 402 adjusts the risk score associated with the “on-us” check by lowering the stored risk score in the data storage 404. The fraud exchange 402 may communicate the adjusted, lower risk score to the check management system 418 which may determine that the “on-us” check can be honored.

In another example, the fraud exchange 402 may accumulate one or more data points suggesting fraudulent behavior received from fraud information sources until a threshold number of data points is received. For example, the web fraud detection system 412 generates a first event which indicates that an account belonging to a specific customer is accessed from an unknown terminal. The customer record management system 424 may generate a second event that the address on the accessed account has been changed. The first and second events independently are not indicative of fraud. However, as the result of the received third event, for example indicating that the account has been closed, the fraud exchange 402 may issue an alert to the customer record management system 424 or a third party system indicating potentially fraudulent activity associated with the account.

Having thus described several aspects of at least one example, it is to be appreciated that various alterations, modifications, and improvements will readily occur to those skilled in the art. For instance, while the bulk of the specification discusses detection of check fraud, examples disclosed herein may also be used in other contexts such as to detect other categories of fraud within industries other than the financial industry, such as the healthcare industry. Such alterations, modifications, and improvements are intended to be part of this disclosure, and are intended to be within the scope of the examples discussed herein. Accordingly, the foregoing description and drawings are by way of example only.

What is claimed is:

1. A computer system for managing and enabling communication of information potentially pertinent to identifying fraudulent activity, the computer system comprising:
a memory storing a plurality of data points identified as pertinent to potentially fraudulent activity, the plurality of data points including a first data point received from a first source system and a second data point received from a second source system different than the first source system;
at least one processor coupled to the memory;
a producer interface executed by the at least one processor and configured to receive, from a plurality of source systems, requests to store the plurality of data points, the plurality of source systems including the first source system and the second source system;
a fraud exchange engine executed by the at least one processor and configured to perform an analysis of the plurality of data points including the first data point and the second data point to produce at least one relational data point, wherein the relational data point is stored in the memory; and
a consumer interface executed by the at least one processor and configured to receive, from at least one target system, a request to retrieve at least one of a set of the plurality of data points and the at least one relational data point.

2. The computer system according to claim 1, wherein the analysis performed by the fraud exchange engine of the first data point and the second data point includes at least one of accumulating, aggregating, filtering, trending and adjusting.

3. The computer system according to claim 2, wherein the fraud exchange engine is configured to produce the at least one relational data point in response to performing the analysis and determining association criteria shared by the first data point and the second data point.

4. The computer system according to claim 2, wherein the fraud exchange engine is configured to perform trending of the first data point and the second data point into the at least one relational data point in response to determining a trend of behavior shared by the first data point and the second data point.

5. The computer system according to claim 2, wherein the fraud exchange engine is configured to adjust a summary of at least one of the plurality of data points stored in the memory in response to receiving at least one of the first data point and the second data point.

6. The computer system according to claim 1, wherein the consumer interface is further configured to receive, from the at least one target system, a request to subscribe to a second set of data points, the second set of data points including at least one of all data points, a set of enumerated data points, a set of relational data points and a set of data points based on association criteria, wherein a subscription associating the at least one target system with the set of data points is stored into the memory, in response to receiving the request.

7. The computer system according to claim 6, wherein the second set of data points includes the first data point and the second data point, the first data point and the second data point represent a different activity, and the fraud exchange engine is further configured to issue, to the at least one target system, a first message corresponding to the first data point and a second message corresponding to the second data point.

8. The computer system according to claim 6, wherein the second set of data points includes the first data point and the second data point, the first data point and the second data point represent a same activity, and the fraud exchange engine is further configured to issue a first message corresponding to the first data point and the second data point.

9. The computer system according to claim 1, wherein the fraud exchange engine is further configured to issue a message corresponding to the at least one relational data point after performing the analysis of the first data point and the second data point and producing the at least one relational data point.

10. The computer system according to claim 1, wherein the consumer interface is further configured to receive, from an agent system, a request to retrieve at least one of a second set of the plurality of data points and the at least one relational data point.

11. The computer system according to claim 1, wherein the consumer interface is configured to communicate to the at least one target system, at least one of the set of data points and the at least one relational data point in response to the request from the at least one target system.

12. The computer system according to claim 1, wherein the consumer interface is configured to receive, from a third source system, a request to retrieve at least one of a second set of data points and the at least one relational data point.

13. The computer system according to claim 1, wherein the producer interface is configured to receive, from the at least one target system, a request to store at least one of a second set of data points and the at least one relational data point.

14. The computer system according to claim 1, wherein the producer interface is configured to receive, from at least one source system, at least one assertion regarding at least one of an identity, an attribute, and an entitlement of a subject and at least one data point relating to the at least one source system.

15. The computer system according to claim 14, wherein the at least one assertion received by producer interface is based on SAML protocol.

16. The computer system according to claim 1, wherein the consumer interface is configured to receive a request to generate at least one assertion about a subject based on at least one of a second set of data points and the at least one relational data point.

17. The computer system according to claim 1, wherein the fraud exchange engine is configured to communicate a message, via the consumer interface, to the at least one target system, altering a process executing on the least one target system.

18. A computer implemented method for managing and enabling communication of information potentially pertinent to identifying fraudulent activity, the method comprising:
receiving, by a computer, a plurality of data points potentially pertinent to identifying fraudulent activity from a plurality of source systems, the plurality of data points including a first data point received from a first source system and a second data point received from a second source system different than the first source system, the plurality of source systems including the first source system and the second source system;
storing, by the computer, the plurality of data points in memory;
performing an analysis of the plurality of data points including the first data point and the second data point to produce at least one relational data point;
storing, by the computer, the at least one relational data point in the memory; and
receiving, by the computer, from at least one target system, a request to retrieve at least one of a set of data points and the at least one relational data point.

19. The method according to claim 18, wherein the act of performing an analysis of the first data point and the second data point further includes performing at least one of accumulating, aggregating, trending, filtering and adjusting.

20. The method according to claim 19, wherein the act of performing the analysis to produce the relational data point is performed in response to determining association criteria shared by the first data point and the second data point.

21. The method according to claim 19, wherein the act of trending the first data point and the second data point to produce the at least one relational data point is performed in response to determining a trend of behavior common to the first data point and the second data point.

22. The method according to claim 19, wherein the act of performing the analysis of the first data point and the second data point includes adjusting a summary of at least one data point stored in the memory in response to receiving at least one of the first data point and the second data point.

23. The method according to claim 18, the method further comprises:
receiving, from the at least one target system, a request to subscribe to a second set of data points, the second set of data points including at least one of all data points, a set of enumerated data points, a set of relational data points and a set of data points based on an association criteria; and
storing, responsive to receiving the request, a subscription associating the at least one target system with the set of data points.

24. The method according to claim 23, wherein the second set of data points includes the first data point and the second data point, the first data point and the second data point pertinent to a different activity, and the method further includes issuing, to the at least one target system, a first message corresponding to the first data point and a second message corresponding to the second data point.

25. The method according to claim 23, wherein the second set of data points includes the first data point and the second data point, the first data point and the second data point pertinent to a same activity, and the method further includes issuing, to the at least one target system, a first message corresponding to the first data point and the second data point.

26. The method according to claim 18, the method further comprises issuing, to the at least one target system, a message corresponding to the at least one relational data point after performing the analysis of the first data point and the second data point and producing the at least one relational data point.

27. The method according to claim 18, the method further comprising:
receiving, from at least one of the plurality of source systems, at least one assertion regarding at least one of an identity, an attribute, an entitlement of a subject and at least one data point relating to the at least one source system; and
storing the at least one assertion in the memory.

28. The method according to claim 27, wherein the act of receiving the at least one assertion includes receiving at least one assertion based on SAML protocol.

29. The method according to claim 18, the method further includes:
receiving a request to generate at least one assertion about a subject from the at least one target system; and
generating the assertion based on at least one of a second set of data points and the at least one relational, in response to receiving the request.

30. The method according to claim 18, the method further includes communicating to the at least one target system, at least one of the set of data points and the at least one relational data point, in response to receiving the request from the at least one target system.

31. The method according to claim 18, the method further includes communicating a message to the at least one target system, altering a process executing on the least one target system.

32. A non-transitory computer readable medium having stored thereon sequences of instruction for managing information potentially pertinent to identifying fraudulent activity including instructions that will cause at least one processor to:
receive a plurality of data points potentially pertinent to identifying fraudulent activity from a plurality of source systems, the plurality of data points including a first data point received from a first source system and a second data point received from a second source system different than the first source system;
store, by a computer, the plurality of data points in memory;
perform an analysis of the plurality of data points including the first data point and the second data point to produce at least one relational data point;
store, by the computer, the at least one relational data point in memory; and
receive, by the computer, from at least one target system, a request to retrieve at least one of a set of data points and the at least one relational data point.

33. The computer readable medium according to claim 30, wherein the instructions cause the at least one processor to perform the analysis of the first data point and the second data point further includes at least one of accumulating, aggregating, trending, filtering and adjusting.

34. The computer readable medium according to claim 31, wherein the instructions cause the at least one processor to produce the at least one relational data point in response to determining association criteria shared by the first data point and the second data point.
